(19) United States
(12) Patent Application Publication
(10) Pub. No.: US 2024/0338852 A1
(43) Pub. Date: Oct. 10, 2024

(54) COLOR DISCRIMINATION DEVICE AND COLOR DISCRIMINATION METHOD

(71) Applicants: SONY SEMICONDUCTOR SOLUTIONS CORPORATION, KANAGAWA (JP); SONY GROUP CORPORATION, TOKYO (JP)

(72) Inventors: YUJI HANADA, KANAGAWA (JP); MASAHIKO NAGUMO, KANAGAWA (JP); KIMIHARU SATO, TOKYO (JP)

(21) Appl. No.: 18/293,748

(22) PCT Filed: Mar. 31, 2022
(86) PCT No.: PCT/JP2022/016636

§ 371 Date: Jan. 30, 2024

(30) Foreign Application Priority Data
Aug. 30, 2021 (JP) 2021-140498

(51) Int. Cl. G06T 7/90; G06T 7/00

(52) U.S. Cl. CPC G06T 7/90; G06T 7/97; G06T 2207/10024; G06T 2207/20081; G06T 2207/20084

(57) ABSTRACT

Provided is a color discrimination device capable of accurately discriminating a color of a subject and having excellent robustness and expandability. The color discrimination device includes: an image acquisition unit that acquires two or more types of images among a visible image including a visible light component obtained by imaging a subject, a reflection suppressing image in which a reflected light component is suppressed, and a reflection component image from which the reflected light component is extracted; and a color discrimination unit that discriminates a color of the subject on the basis of the two or more types of images acquired by the image acquisition unit.

### TECHNICAL FIELD

The present disclosure relates to a color discrimination device and a color discrimination method.

### BACKGROUND ART

In order to quantitatively measure a color, an RGB camera, a multispectral camera, a spectroscopic instrument, and the like are generally used. All of these devices measure colors by taking colors as wavelengths.

Even with the same color, it is difficult to accurately discriminate the color only by the wavelength of the reflected light from the target member for the target members having different surface treatment specifications. For example, in a case where one of two target members of the same color is solid coated and the other is metallic coated, it is not easy to discriminate these colors by the wavelengths of the reflected light from the target members.

Patent Document 1 discloses a technique of irradiating a metallic coated target member with light from an oblique direction, receiving reflected light of the light from a plurality of directions, and calculating a color difference in each direction to search for an approximate color of the target member at a high speed (Patent Document 1).

### CITATION LIST

### Patent Document

Patent Document 1: Japanese Patent No. 4623842

### SUMMARY OF THE INVENTION

### Problems to be Solved by the Invention

In Patent Document 1, it is necessary to image a target member from a plurality of directions and calculate a color difference in each direction, which is complicated in processing and takes time to discriminate a color. In addition, an error may occur in the calculation of the color difference due to a change in ambient light or a distance from the target member to the camera.

In addition, in a system using an existing RGB camera, multispectral camera, or the like, a target member is illuminated by an illumination light source, and reflected light thereof is captured by a light receiving element to discriminate a color of the target member. However, in the target member having a complicated surface shape, since the amount of reflected light with respect to the illumination light changes depending on the place, the variation in brightness of the captured image becomes large, and there is a possibility that an accurate color cannot be discriminated.

Furthermore, in a case where colors of a plurality of target members flowing through the manufacturing line are discriminated, the distance to the illumination light source may vary for each target member. When the distance varies, the amount of reflected light from the target member changes, and the color of the target member cannot be correctly discriminated.

As described above, an existing RGB camera or multispectral camera cannot be said to be excellent in robustness, and may not be able to accurately discriminate the color of the target member.

In addition, even in a case where a new color is added to a target member or the like, it is desirable to have expandability capable of discriminating a color without lowering accuracy. However, in an existing system, in a case where the new color is similar to a color already registered, the color cannot be accurately discriminated.

Therefore, the present disclosure provides a color discrimination device and a color discrimination method capable of accurately discriminating a color of a subject and having excellent robustness and expandability.

### Solutions to Problems

In order to solve the above problem, according to the present disclosure, there is provided a color discrimination device including:

an image acquisition unit that acquires two or more types of images among a visible image including a visible light component obtained by imaging a subject, a reflection suppressing image in which a reflected light component is suppressed, and a reflection component image from which the reflected light component is extracted; and a color discrimination unit that discriminates a color of the subject on the basis of the two or more types of images acquired by the image acquisition unit.

The color discrimination unit may discriminate the color of the subject on the basis of a result of comparing each of the two or more types of images acquired by the image acquisition unit with a plurality of reference images each having a known color and a surface treatment specification.

The color discrimination unit may discriminate the color of the subject on the basis of a result of comparing each of the two or more types of images acquired by the image acquisition unit with a plurality of reference images each having a known color and a surface treatment specification captured under at least one of different environmental conditions or imaging conditions.

The color discrimination device may further include an image extraction unit that extracts a partial image of a specific part of the subject from each of the two or more types of images and extracts a partial reference image of the specific part from each of the plurality of reference images, in which the color discrimination unit may discriminate the color of the subject on the basis of a result of comparing each of two or more types of the partial image with each of a plurality of the partial reference image.

The color discrimination device may further include:

a model construction unit that constructs a machine learning model that discriminates a color of the subject on the basis of the two or more types of images input; and

a learning unit that performs learning of the machine learning model on the basis of the plurality of reference images,

in which the color discrimination unit may discriminate the color of the subject on the basis of a color output from the machine learning model when the two or more types of images are input to the machine learning model.

The learning unit may learn the machine learning model on the basis of the plurality of reference images each having a known color and a surface treatment specification.

The learning unit may learn the machine learning model on the basis of the plurality of reference images captured under at least one of a plurality of different environmental conditions or imaging conditions.

The learning unit may learn the machine learning model on the basis of the plurality of reference images each having a different posture of the subject.

The machine learning model may include a neural network having an updatable weighting factor, and the learning unit may update the weighting factor on the basis of the plurality of reference images.

Each of the plurality of reference images may include a reference visible image including a visible light component, a reference reflection suppressing image in which a reflected light component is suppressed, and a reference reflection component image from which the reflected light component is extracted, and the learning unit may learn the machine learning model on the basis of a plurality of the reference visible image, a plurality of the reference reflection suppressing image, and a plurality of the reference reflection component image corresponding to the plurality of reference images.

The model construction unit may be provided in a server connected to a network.

The color discrimination device may further include:

a digitizing unit that digitizes each of the two or more types of images acquired by the image acquisition unit and the plurality of reference images; and

a difference calculation unit that calculates a difference between a value obtained by digitizing each of the two or more types of images by the digitizing unit and a value obtained by digitizing the plurality of reference images by the digitizing unit,

in which the color discrimination unit may discriminate the color of the subject on the basis of the difference calculated by the difference calculation unit.

Each of the plurality of reference images may include a reference visible image including a visible light component, a reference reflection suppressing image in which a reflected light component is suppressed, and a reference reflection component image from which the reflected light component is extracted, and

the difference calculation unit may calculate the difference on the basis of a value obtained by digitizing each of the visible image, the reflection suppressing image, and the reflection component image corresponding to the two or more types of images by the digitizing unit and a value obtained by digitizing each of the reference visible image, the reference reflection suppressing image, and the reference reflection component image corresponding to each of the plurality of reference images by the digitizing unit.

The difference calculation unit may calculate a sum of a first difference between a value obtained by digitizing the visible image by the digitizing unit and a value obtained by digitizing the reference visible image by the digitizing unit, a second difference between a value obtained by digitizing the reflection suppressing image by the digitizing unit and a value obtained by digitizing the reference reflection suppressing image by the digitizing unit, and a third difference between a value obtained by digitizing the reflection component image by the digitizing unit and a value obtained by digitizing the reference reflection component image by the digitizing unit, and the color discrimination unit may determine, as the color of the subject, a color of the reference image having a minimum sum calculated by the difference calculation unit.

The color discrimination device may further include:

an imaging section that outputs a polarized image obtained by imaging the subject; and

a polarization signal processing unit that generates the visible image, the reflection suppressing image, and the reflection component image on the basis of the polarized image,

in which the image acquisition unit may generate two or more types of images among the visible image, the reflection suppressing image, and the reflection component image on the basis of the polarized image.

The color discrimination device may further include an illumination light source that illuminates the subject with light polarized at a predetermined polarization angle when the imaging section images the subject.

The surface treatment specification may include at least one of metallic coating or solid coating of the subject.

According to the present disclosure, there is provided a color discrimination method including: acquiring two or more types of images among a visible image including a visible light component obtained by imaging a subject, a reflection suppressing image in which a reflected light component is suppressed, and a reflection component image from which the reflected light component is extracted; and discriminating a color of the subject on the basis of the two or more types of images previously acquired.

### BRIEF DESCRIPTION OF DRAWINGS

FIG. 1 is a block diagram illustrating an overall configuration of a color discrimination system according to a first embodiment.

FIG. 2 is a cross-sectional view of an imaging section in a camera.

FIG. 3 is a perspective view of a wire grid polarizing element.

FIG. 4 is a plan layout diagram of a polarizing filter.

FIG. 5A is a diagram illustrating polarization characteristics of a polarizing filter.

FIG. 5B is a diagram illustrating polarization characteristics of a polarizing filter.

FIG. 5C is a diagram illustrating polarization characteristics of a polarizing filter.

FIG. 6 is a functional block diagram of a color discrimination device.

FIG. 7 is a diagram for explaining a partial image.

FIG. 8 is a functional block diagram illustrating an internal configuration of a RAW image processing unit of FIG. 6.

FIG. 9 is a functional block diagram illustrating an internal configuration of a polarization signal processing unit of FIG. 8.

FIG. 10 is a functional block diagram illustrating an internal configuration of a color conversion unit.

FIG. 11 is a diagram for explaining processing of a CIELAB color space conversion unit.

FIG. 12 is a block diagram illustrating a schematic configuration of a color discrimination system according to a second embodiment.

FIG. 13 is a functional block diagram illustrating an internal configuration of a color discrimination unit.

FIG. 14 is a diagram illustrating an example of a neural network.

FIG. 15 is a diagram illustrating an example in which the posture of the same target member is variously changed.

FIG. 16 is a flowchart illustrating a processing operation of a color discrimination unit according to a third embodiment.

FIG. 17 is a block diagram illustrating an example of a schematic configuration of a vehicle control system.

FIG. 18 is an explanatory diagram illustrating an example of installation positions of an outside-vehicle information detecting section and an imaging section.

### MODE FOR CARRYING OUT THE INVENTION

Hereinafter, embodiments of a color discrimination device and a color discrimination method will be described with reference to the drawings. Hereinafter, the main components of the color discrimination device and the color discrimination method will be mainly described, but the color discrimination device and the color discrimination method may have components and functions that are not illustrated or described. The following description does not exclude components and functions that are not illustrated or described.

### First Embodiment

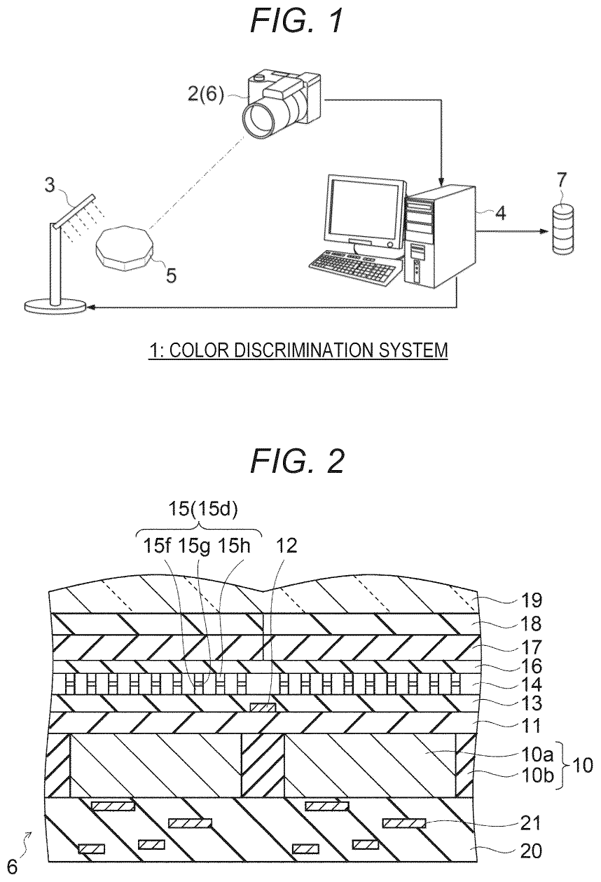

FIG. 1 is a block diagram illustrating an overall configuration of a color discrimination system 1 according to a first embodiment of the present disclosure. The color discrimination system 1 of FIG. 1 includes a camera 2, an illumination light source 3, and a personal computer (PC) 4.

The camera 2 images a target member 5. The target member 5 is an arbitrary member having some color. In the present specification, the target member 5 may be referred to as a subject. The target member 5 may be, for example, an industrial product flowing in a manufacturing line. According to the color discrimination system 1 of the present disclosure, in a case where the target member 5 of a specific color is attached to any device, it is possible to check whether or not the target member 5 has a designated color before attaching the target member 5 to the device, and prevent the target member 5 of a wrong color from being attached to the device.

The camera 2 includes an imaging section (also referred to as a light receiving element) 6. The imaging section 6 photoelectrically converts the reflected light from the target member 5 to generate at least a polarized image. The polarized image is an image having a specific polarized component. The camera 2 may photoelectrically convert reflected light in a wavelength band of visible light to generate a visible image, similarly to a normal image sensor, in addition to generating a polarized image.

FIG. 2 is a cross-sectional view of the imaging section 6 in the camera 2, and illustrates a back-illuminated cross-sectional structure. The imaging section 6 includes a pixel unit 10. In the pixel unit 10, a plurality of photoelectric conversion units 10a divided for each pixel and a light shielding member 10b arranged at a boundary portion of the pixel are formed. A planarization layer 11 is disposed on the photoelectric conversion unit 10a. A light shielding layer 12 is disposed in the pixel boundary region of the planarization layer 11. An underlying insulating layer 13 is disposed on the planarization layer 11 and the light shielding layer 12. An insulating layer 14 and a wire grid polarizing element 15 having a line-and-space structure are disposed on the underlying insulating layer 13. Note that the imaging section 6 is not limited to the back-illuminated type as illustrated in FIG. 2, and may be a front-illuminated type.

A planarization layer 17 is disposed on the insulating layer 14 and the wire grid polarizing element 15 with a protective layer 16 interposed therebetween. A color filter layer 18 is disposed on the planarization layer 17. The color filter layer 18 may have filter layers of the three RGB colors, or may have filter layers of cyan, magenta, and yellow that are complementary colors of the three RGB colors. Alternatively, a filter layer that transmits color other than visible light such as infrared light may be included, a filter layer having a multispectral characteristic may be included, or a filter layer of subtractive color, such as white, may be included. By transmitting light other than visible light such as infrared light, sensing information such as depth information can be detected. An on-chip lens 19 is disposed on the color filter layer 18. Another substrate 20 is bonded to the surface of the pixel unit 10 opposite to the light incident surface by Cu—Cu connection, bump, via, or the like. A wiring layer 21 and the like are disposed on the substrate 20.

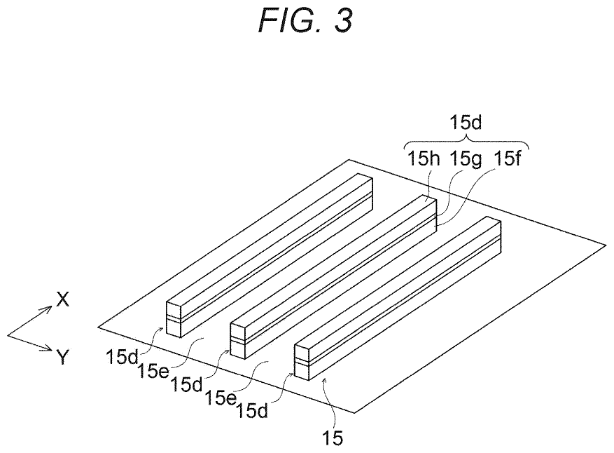

FIG. 3 is a perspective view of the wire grid polarizing element 15. The wire grid polarizing element 15 includes a plurality of protruding line portions 15d extending in one direction and a space portion 15e between each line portion 15d. There is a plurality of types of polarizing elements 15 in which extending directions of the line portions 15d are different from each other. More specifically, there may be three or more types of polarizing elements 15, and for example, an angle formed by a direction in which a photoelectric conversion unit 10a is arrayed and a direction in which the line portions 15d extend may be three types of 0 degrees, 60 degrees, and 120 degrees. Alternatively, the angle between the array direction of the photoelectric conversion units 10a and the extending directions of the line portions 15d may be four types of angles of 0 degrees, 45 degrees, 90 degrees, and 135 degrees, or may be other angles. Alternatively, the plurality of polarizing elements 15 may polarize only in a single direction. The material of the plurality of polarizing elements 15 may be a metal material such as aluminum or tungsten.

As described above, each polarizing element 15 has a structure in which the plurality of line portions 15d extending in the one direction X is arranged at intervals in the direction Y intersecting the one direction X as illustrated in FIG. 3. There is a plurality of types of polarizing elements 15 in which the extending directions X of the line portions 15d are different from each other. These polarizing elements 15 are disposed separately from one another so as to overlap with a part of a two-dimensional array of the plurality of photoelectric conversion units 10a.

The line portion 15d has a laminated structure in which a light reflection layer 15f, an insulating layer 15g, and a light absorbing layer 15h are laminated. The light reflection layer 15f includes, for example, a metal material such as aluminum. The insulating layer 15g includes, for example, SiO2 or the like. The light absorbing layer 15h is, for example, a metal material such as tungsten.

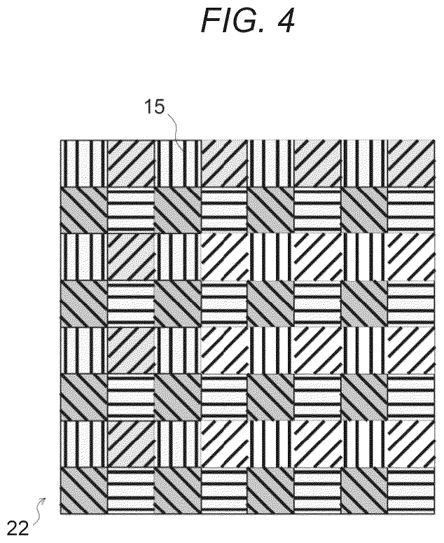

The wire grid polarizing element 15 forms a polarizing filter 22. FIG. 4 is a plan layout diagram of the polarizing filter 22. As illustrated in FIG. 4, four types of polarizing filters 22 having the same size as the pixels are arranged in the entire region of the imaging surface. Each polarizing filter 22 is formed of a wire grid polarizing element 15 illustrated in FIG. 3. The four types of polarizing filters 22 are formed by arranging the longitudinal direction of the line portion of the wire grid polarizing element 15 in directions of, for example, 0 degrees, 45 degrees, 90 degrees, and 135 degrees.

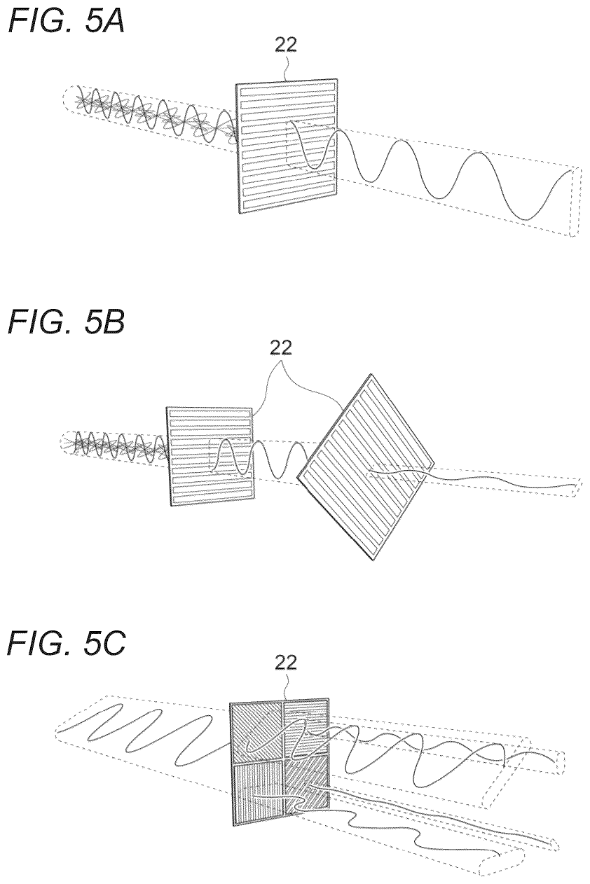

FIGS. 5A, 5B, and 5C are diagrams illustrating polarization characteristics of the four types of polarizing filters 22. As illustrated in FIG. 5A, each polarizing filter 22 transmits only polarized light in a specific direction. In addition, as illustrated in FIG. 5B, the intensity of the light that has entered the polarizing filter 22 and is transmitted through the polarizing filter 22 changes according to the vibration direction of the light and the inclination of the polarizer of the polarizing filter 22. Furthermore, as illustrated in FIG. 5C, instead of rotating the polarizing filter 22 to generate a plurality of images, a plurality of polarizers having different polarization angles is arranged adjacent to each other, so that a plurality of pieces of polarization information can be simultaneously acquired.

Although FIG. 4 illustrates an example in which the polarizing filter 22 is arranged in the entire region of the imaging surface of the imaging section 6, it is possible to generate a polarized image and a visible image by partially arranging the polarizing filter 22 on the imaging surface. For example, a plurality of pixels arranged along the imaging surface may be arranged in a two-dimensional direction with 2×2 pixels of red, green, blue, and white as a set, and the polarizing filter 22 may be arranged only on the light incident side of the white pixels. As a result, a polarized image can be generated on the basis of the white pixels on which the polarizing filter 22 is arranged, and a visible image can be generated on the basis of the red, green, and blue pixels on which the polarizing filter 22 is not arranged.

Although not illustrated in the cross-sectional view of the imaging section 6 in FIG. 2, the pixel signal photoelectrically converted by the photoelectric conversion unit 10a is converted into a digital pixel signal by an AD conversion unit arranged on another substrate 20 laminated on the pixel unit. This digital pixel signal is also called RAW pixel data, and is pixel data constituting a polarized image. The camera 2 in FIG. 1 outputs RAW pixel data. The RAW pixel data is, for example, 12 bit data for each pixel.

In order to make the plurality of polarized images clearer, it is desirable to image the target member 5 with the camera 2 in a state where the target member 5 is illuminated by the illumination light source 3. In particular, by using a polarized light source that emits polarized light of a specific polarized component as the illumination light source 3, the image quality of a plurality of polarized images generated by the imaging section 6 can be further improved. Note that the illumination light source 3 may be a light source that emits visible light, but a polarized light source is more desirable in order to improve the image quality of a plurality of polarized images generated by the imaging section 6.

The polarized image generated by the imaging section 6 is input to the PC 4 illustrated in FIG. 1. As described later, the PC 4 functions as a main part of a color discrimination device that discriminates the color of the target member 5 on the basis of the polarized image of the target member 5. In addition, in a case where the discriminated color is different from the assumed color, the PC 4 may call attention by turning on or blinking a warning lamp 7 or the like. For example, in a case where the target member 5 having a color different from the assumed color is found among the plurality of target members 5 flowing in the manufacturing line, the warning lamp 7 may be turned on or blink to remove the target member 5 from the manufacturing line.

Note that the color discrimination of the target member 5 is not necessarily performed by the PC 4. The processing may be performed by a logic chip laminated on the imaging section 6, or may be performed by an application processor (hereinafter, AP) connected to the imaging section 6 as described later. As described above, the color discrimination device may be configured using a device other than the PC 4.

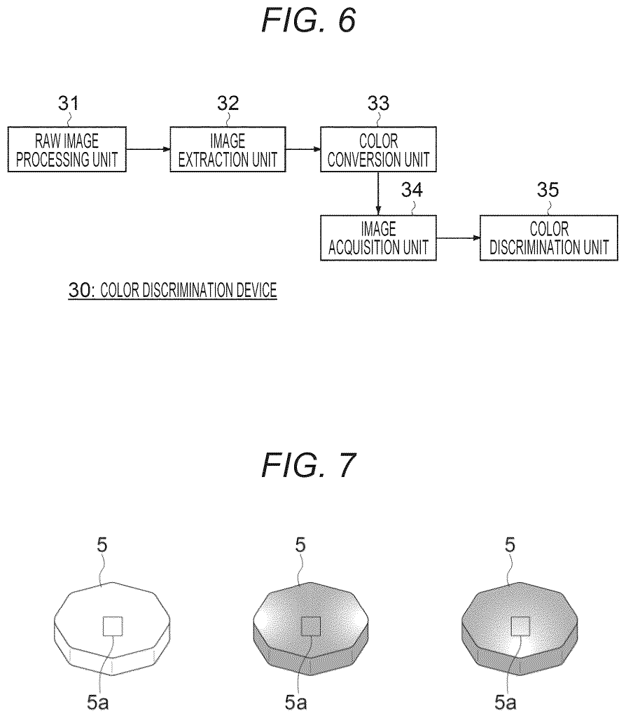

FIG. 6 is a functional block diagram of the color discrimination device 30. The color discrimination device 30 in FIG. 6 may be executed by the PC 4 or the like as software processing, or may be executed by a dedicated chip, a digital signal processor (DSP), or the like. Furthermore, the color discrimination device 30 may be executed by software processing by a processor built in the camera 2, a dedicated chip built in the camera 2, DSP, or the like.

As illustrated in FIG. 6, the color discrimination device 30 includes a RAW image processing unit 31, an image extraction unit 32, a color conversion unit 33, an image acquisition unit 34, and a color discrimination unit 35. A part of the processing in the color discrimination device 30 may be executed on the camera 2 side, and the remaining processing may be executed by the PC 4 or the like. For example, the processing of the RAW image processing unit 31, the image extraction unit 32, and the color conversion unit 33 may be executed on the camera 2 side, and the processing of the image acquisition unit 34 and the color discrimination unit 35 may be executed on the PC 4 side.

The RAW image processing unit 31 performs development processing on the RAW pixel data output from the camera 2, and generates pixel data including three colors of RGB, for example. Each piece of pixel data is, for example, 8-bit data. In the present specification, one frame of RAW pixel data for each pixel is referred to as a RAW image, and one frame of pixel data of three colors of RGB output from the RAW image processing unit 31 is referred to as an RGB image.

As described later, the RAW image processing unit 31 generates, on the basis of the RAW image output from the camera 2, a visible image including a visible light component obtained by imaging the target member 5 (subject), a reflection suppressing image in which a reflected light component is suppressed, and a reflection component image in which a reflected light component is extracted. Each of these three types of images includes RGB pixel data for one frame.

The image extraction unit 32 extracts a partial image of a specific part from each of the visible image, the reflection suppressing image, and the reflection component image output from the RAW image processing unit 31. For example, as illustrated in FIG. 7, the partial image is an image (partial image) of the rectangular region 5a of a part of the target member 5. The specific part refers to a representative part representing the color of the target member 5. The sizes of the specific part and the partial image need to be the same in the three types of images. Note that the shape of the partial image extracted by the image extraction unit 32 does not necessarily have a rectangular shape, but in the present specification, an example in which the image extraction unit 32 extracts a partial image having the same pixel position and the same rectangular shape from each of the three types of images will be described.

The color conversion unit 33 performs processing of digitizing the three types of images extracted by the image extraction unit 32. The color conversion unit 33 is not an essential constituent block, and may be omitted. However, by providing the color conversion unit 33, RGB pixel data can be converted into numerical data having color information approximate to characteristics of human eyes. Furthermore, by providing the color conversion unit 33, objective comparison processing with the reference image can be easily performed.

The image acquisition unit 34 acquires two or more types of images of an arbitrary combination of a visible image including a visible light component obtained by imaging the target member 5 (subject), a reflection suppressing image in which a reflected light component is suppressed, and a reflection component image from which the reflected light component is extracted. That is, the image acquisition unit 34 acquires two or more types of images of an arbitrary combination among the visible image, the reflection suppressing image, and the reflection component image. Note that the two or more types of images acquired by the image acquisition unit 34 are partial images extracted by the image extraction unit 32.

The color discrimination unit 35 discriminates the color of the target member 5 (subject) on the basis of two or more types of images acquired by the image acquisition unit 34. As will be described later, even if the colors of the plurality of target members 5 are the same, the surface treatment specifications may be different. For example, two target members 5 are both white, but one may be metallic coating and the other may be solid coating. In this case, the color discrimination unit 35 can correctly discriminate whether the metallic coating is white or the solid coating is white.

More specifically, the color discrimination unit 35 discriminates the color of the subject on the basis of a result of comparing each of the two or more types of images acquired by the image acquisition unit 34 with a plurality of reference images each having a known color and a surface treatment specification. Furthermore, the color discrimination unit 35 may discriminate the color of the subject on the basis of a result of comparing each of the two or more types of images acquired by the image acquisition unit 34 with a plurality of reference images respectively having known colors and surface treatment specifications captured under at least one of different environmental conditions or imaging conditions.

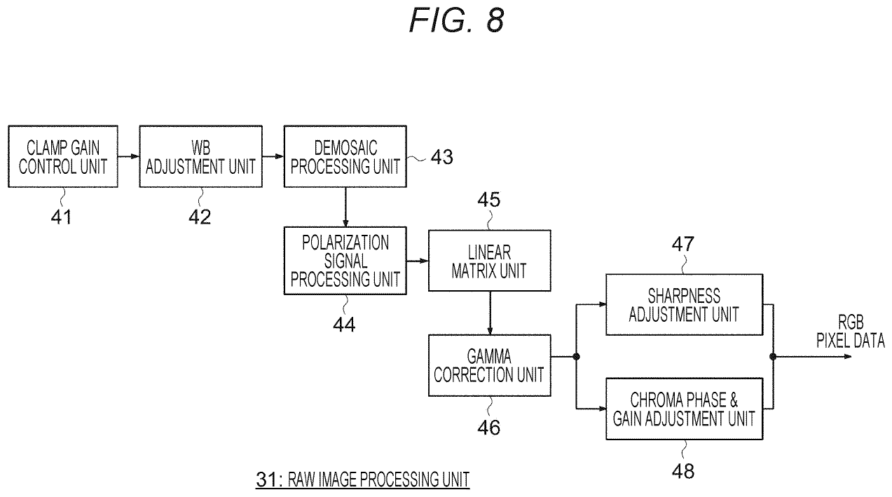

FIG. 8 is a functional block diagram illustrating an internal configuration of the RAW image processing unit 31 of FIG. 6. As illustrated in FIG. 8, the RAW image processing unit 31 includes a clamp gain control unit 41, a white balance (WB) adjustment unit 42, a demosaic processing unit 43, a polarization signal processing unit 44, a linear matrix unit 45, a gamma correction unit 46, a sharpness adjustment unit 47, and a chroma phase & gain adjustment unit 48.

The clamp gain control unit 41 controls the clamp gain of the RAW image. The white balance adjustment unit 42 adjusts the white balance of the RAW image whose clamp gain is controlled by the clamp gain control unit 41. The demosaic processing unit 43 performs demosaic processing on the RAW image after white balance adjustment. The demosaic processing is processing of interpolating pixel data of each pixel on the basis of pixel data of peripheral pixels.

As will be described later, the polarization signal processing unit 44 generates the above-described visible image, reflection suppressing image, and reflection component image from the image after demosaic processing. The linear matrix unit 45 performs linearization processing so that the relationship between the change in pixel data and the change in gradation becomes linear. The gamma correction unit 46 performs gamma correction processing on the image output from the linear matrix unit 45. The sharpness adjustment unit 47 performs processing of emphasizing the contour of the image output from the gamma correction unit 46. The chroma phase & gain adjustment unit 48 performs chroma phase adjustment and gain adjustment on the image output from the gamma correction unit 46.

By performing the processing of the sharpness adjustment unit 47 and the chroma phase & gain adjustment unit 48, an RGB image including RGB pixel data is generated.

The processing order of each processing block in the RAW image processing unit 31 illustrated in FIG. 8 can be arbitrarily changed. In addition, some processing blocks may be omitted. For example, at least one of the linear matrix unit 45, the gamma correction unit 46, the sharpness adjustment unit 47, or the chroma phase & gain adjustment unit may be omitted.

FIG. 9 is a functional block diagram illustrating an internal configuration of the polarization signal processing unit 44 in FIG. 8. As illustrated in FIG. 9, the polarization signal processing unit 44 includes a non-polarization intensity calculation unit 51, a polarization intensity calculation unit 52, and a subtractor 53.

An image after the demosaic processing in FIG. 8 is input to the polarization signal processing unit 44. The image input to the polarization signal processing unit 44 is, for example, a polarized image of four different polarization angles. Hereinafter, an example will be described in which the four polarized images input to the polarization signal processing unit 44 are polarized images with polarization angles of 0 degrees, 45 degrees, 90 degrees, and 135 degrees.

The non-polarization intensity calculation unit 51 calculates an average value of the four polarized images as illustrated in Expression (1). “0 deg”, “45 deg”, “90 deg”, and “135 deg” in Expression (1) are polarized images of 0 degrees, 45 degrees, 90 degrees, and 135 degrees, respectively. In practice, Expression (1) is calculated for each pixel of the four polarized images.

$$\begin{matrix}[ Math . 1 ] & \\ \frac{0 d e g + 45 d e g + 90 d e g + 135 d e g}{4} & ( 1 )\end{matrix}$$

By performing the calculation of Expression (1) for each pixel, a visible image uniformly including polarized components of four polarization angles is generated. As described above, the visible image can be generated from the polarized image without capturing the visible image with the camera 2.

The polarization intensity calculation unit 52 calculates the polarization intensities of the four polarized images by Expression (2). Since polarized light is generated by reflection, the polarization intensity is equivalent to the reflected light intensity, and the reflected light component can be extracted by Expression (2).

$$\begin{matrix}[ Math . 2 ] & \\ \frac{\sqrt{( {( 0 d e g - 90 d e g )}^{2} + {( 45 d e g - 135 d e g )}^{2}}}{2} & ( 2 )\end{matrix}$$

By performing the calculation of Expression (2) for each pixel, a reflection component image obtained by extracting the reflected light components of the four polarized images having different polarization angles is generated.

The subtractor 53 calculates a difference between the visible image calculated by the non-polarization intensity calculation unit 51 and the reflection component image calculated by the polarization intensity calculation unit 52. This calculation is performed for each pixel. As a result, a reflection suppressing image in which the reflected light component is suppressed is generated.

The visible image, the reflection suppressing image, and the reflection component image generated by the polarization signal processing unit 44 are input to the image extraction unit 32, and partial images having the same pixel position and the same shape are extracted. The three types of partial images extracted by the image extraction unit 32 are input to the color conversion unit 33.

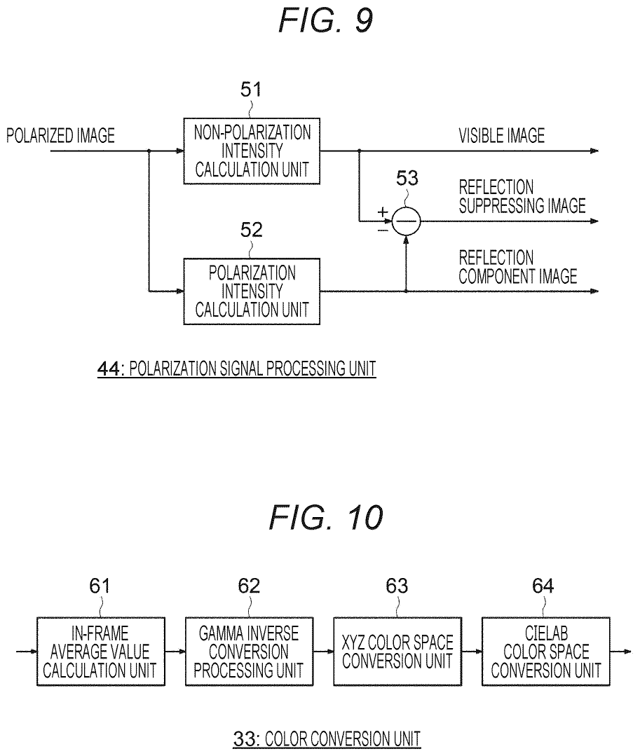

FIG. 10 is a functional block diagram illustrating an internal configuration of the color conversion unit 33. As illustrated in FIG. 10, the color conversion unit 33 includes an in-frame average value calculation unit 61, a gamma inverse conversion processing unit 62, an XYZ color space conversion unit 63, and a CIELAB color space conversion unit 64.

The in-frame average value calculation unit 61 calculates an average value of the pixel data for each color for each of the three types of partial images. The gamma inverse conversion processing unit 62 performs gamma inverse conversion on each pixel data in the three types of partial images to generate pixel data R′G′B′ for each partial image.

The XYZ color space conversion unit 63 converts the pixel data R′, G′, and B′ into XYZ color space data using, for example, a matrix of the following Expression (3).

$$\begin{matrix}[ Math . 3 ] & \\ ( \begin{matrix}X \\ Y \\ Z\end{matrix} ) = ( \begin{matrix}0.4124 & 0.3576 & 0.1805 \\ 0.2126 & 0.7152 & 0.0722 \\ 0.0193 & 0.1192 & 0.9505\end{matrix} ) ( \begin{matrix}{R}^{′} \\ {G}^{′} \\ {B}^{′}\end{matrix} ) & ( 3 )\end{matrix}$$

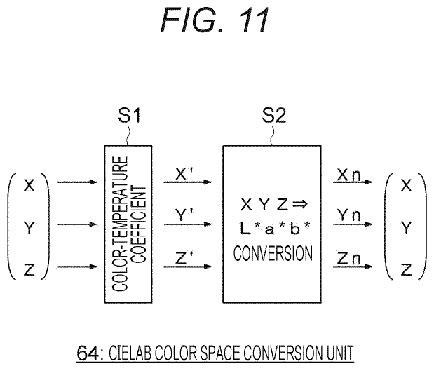

The CIELAB color space conversion unit 64 converts XYZ color space data into CIELAB color space data. FIG. 11 is a diagram for explaining processing of the CIELAB color space conversion unit 64. First, color space data X′Y′Z′ corrected by the color-temperature coefficient is generated from the XYZ color space data (step S1).

Next, the color space data X′Y′Z′ on the XYZ coordinates is converted into color space data XnYnZn on the L*a*b*coordinates (step S2).

By performing conversion into the CIELAB color space, an image approximate to human perception is obtained.

The image acquisition unit 34 in FIG. 6 acquires two or more types of images from among the visible image, the reflection suppressing image, and the reflection component image color-converted by the color conversion unit 33. The reason why the image acquisition unit 34 acquires two or more types of images is that, for example, there is a possibility that colors of a plurality of target members 5 having different surface treatment specifications cannot be accurately discriminated only by a visible image. Since the reflection suppressing image is an image including no polarized component, it is possible to identify a difference in the surface treatment specification of the target member 5 by combining the visible image and the reflection suppressing image. For example, there is a difference in reflection characteristics such as a reflection direction and reflection intensity when the light from the illumination light source 3 is reflected on the surface of the target member 5 between the case where the target member 5 is subjected to metallic coating and the case where the target member 5 is subjected to solid coating. Since the visible image and the reflection suppressing image have different ratios including reflected light from the target member 5, color discrimination can be performed in consideration of a difference in surface treatment specifications of the target member 5 by combining both images.

Although the example in which the image acquisition unit 34 acquires the visible image and the reflection suppressing image has been described above, also in a case where the image acquisition unit 34 acquires the visible image and the reflection component image, or in a case where the image acquisition unit 34 acquires the reflection suppressing image and the reflection component image, color discrimination can be similarly performed in consideration of the surface treatment specification of the target member 5.

In addition, in a case where the target member 5 has a complicated shape, a reflection direction and reflection intensity of light from the illumination light source 3 greatly change depending on a place. When the image acquisition unit 34 acquires two or more types of images, the color of the target member 5 can be accurately estimated even if the reflection direction and the reflection intensity of the light reflected by the target member 5 greatly change depending on the place of the target member 5.

The color discrimination unit 35 discriminates the color of the target member 5 on the basis of a result of comparing each of the two or more types of images acquired by the image acquisition unit 34 with a plurality of reference images each having a known color. A specific processing procedure of the color discrimination unit 35 is not limited to one. For example, the color discrimination unit 35 can discriminate the color of the target member 5 using machine learning. Alternatively, it is conceivable that the color discrimination unit 35 compares the image of the target member 5 with the images of the plurality of reference images without using machine learning, and selects the color of the reference image closest to the image of the target member 5. A typical processing procedure of the color discrimination unit 35 will be described later.

As described above, the color discrimination device 30 according to the first embodiment acquires two or more types of images from among the visible image, the reflection suppressing image, and the reflection component image generated on the basis of the polarized image obtained by imaging the target member 5, and discriminates the color of the target member 5. The acquired two or more types of images have different ratios including reflected light from the target member 5, and thus, it is possible to accurately discriminate the color of the target member 5 in consideration of the surface treatment specification of the target member 5, a change in hue due to a complicated shape of the target member 5, and the like.

According to the present embodiment, the visible image, the reflection suppressing image, and the reflection component image can be generated only by imaging the polarized image with the camera 2, and the color of the target member 5 can be easily and accurately discriminated on the basis of two or more types of images among the generated three types of images.

As will be described later, a reference image obtained by imaging the target member 5 whose color and surface treatment specification are known is prepared in advance, and the color of the target member 5 can be accurately discriminated on the basis of a result of comparing the two or more types of images described above for the target member 5 whose color is desired to be discriminated with the reference image. In addition, it is possible to realize a color discrimination device excellent in robustness and expandability by preparing a large number of reference images such as imaging conditions, environmental conditions, approximate colors, and multiple postures in advance.

### Second Embodiment

The color discrimination device 30 according to the second embodiment discriminates the color of the target member 5 using machine learning.

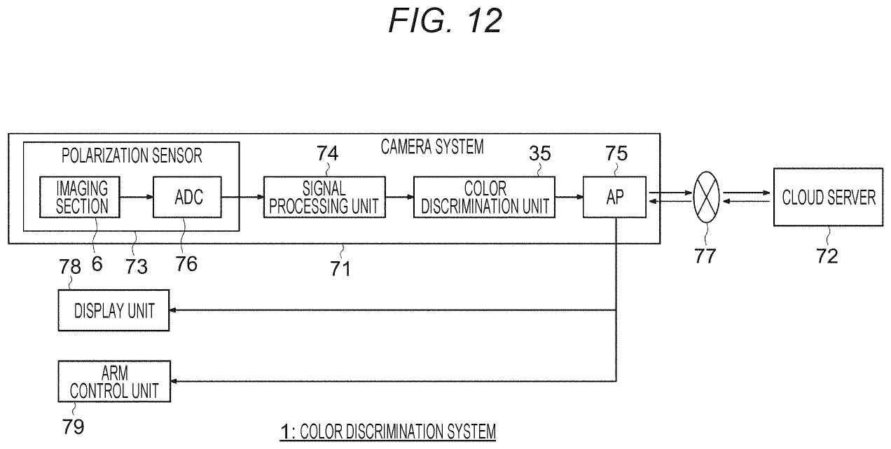

FIG. 12 is a block diagram illustrating a schematic configuration of a color discrimination system 1 according to a second embodiment. The color discrimination system 1 in FIG. 12 includes a camera system 71 and a cloud server 72.

The camera system 71 of FIG. 12 is obtained by combining the functions of the camera 2 and the PC 4 of FIG. 1. A camera system 71 in FIG. 12 includes a polarization sensor 73, a signal processing unit 74, a color discrimination unit 35, and an application processor (AP) 75. The camera system 71 constitutes a main part of the color discrimination device 30. The signal processing unit 74 and the color discrimination unit 35 in FIG. 12 may be integrated into one chip, and the chip of the application processor 75 may be arranged at a stage subsequent to the chip including the signal processing unit 74 and the color discrimination unit 35.

The polarization sensor 73 has a function equivalent to that of the imaging section 6 illustrated in FIGS. 2 to 4. The polarization sensor 73 includes an imaging section 6 and an analog-digital converter (hereinafter, an ADC) 76. The substrate on which the imaging section 6 is arranged and the substrate on which the ADC 76 is arranged may be joined by Cu—Cu connection, bump, via, or the like to form one chip. Alternatively, the pixel unit in which the imaging section 6 is arranged and the signal processing unit in which the ADC 76 is arranged may be formed on the same wafer.

The signal processing unit 74 performs processing of the RAW image processing unit 31, the image extraction unit 32, the color conversion unit 33, and the image acquisition unit 34 illustrated in FIG. 6. Note that at least part of the processing of the RAW image processing unit 31 illustrated in detail in FIG. 8 may be performed inside the polarization sensor 73. Note that, in the present embodiment, the color conversion unit 33 may be omitted. That is, the visible image, the reflection suppressing image, and the reflection component image extracted by the image extraction unit 32 may be input to the image acquisition unit 34 without performing color conversion. The image acquisition unit 34 acquires two or more types of images from the visible image, the reflection suppressing image, and the reflection component image in a state where color conversion is not performed. The acquired two or more types of images are input to the color discrimination unit 35.

The signal processing unit 74 and the color discrimination unit 35 may be arranged in separate chips. In this case, data (packet) is transmitted and received between the two chips in accordance with, for example, the mobile industry processor interface (MIPI) standard, and the header of the packet includes information for identifying which data is the visible image, the reflection suppressing image, or the reflection component image.

In addition, the color discrimination unit 35 in FIG. 12 may be provided on the cloud server 72 side, the processing of the signal processing unit 74 may be performed by the camera system 71, and the processing of the color discrimination unit 35 may be performed by the cloud server 72.

The color discrimination unit 35 discriminates the color of the target object by inputting two or more types of images obtained by imaging the target member 5 to a model (hereinafter, a machine learning model) generated by machine learning. A detailed processing operation of the color discrimination unit 35 will be described later.

The application processor 75 performs control to display the color of the target member 5 discriminated by the color discrimination unit 35 on the display unit 78, and removes the target member 5 determined to be a defective product by the color discriminated by the color discrimination unit 35 from the manufacturing line by an arm control unit 79. The control target by the application processor 75 is arbitrary, and the application processor 75 may control a control target other than the display unit 78 and the arm control unit 79.

In addition, the application processor 75 has a function of transmitting and receiving data to and from the cloud server 72 via a network 77. The cloud server 72 manages a model generated by machine learning. That is, the cloud server 72 has a function of a model construction unit that constructs a model for discriminating the color of the target member 5 on the basis of the input two or more types of images. The application processor 75 receives the learned model from the cloud server 72 via the network 77 and transfers the model to the color discrimination unit 35.

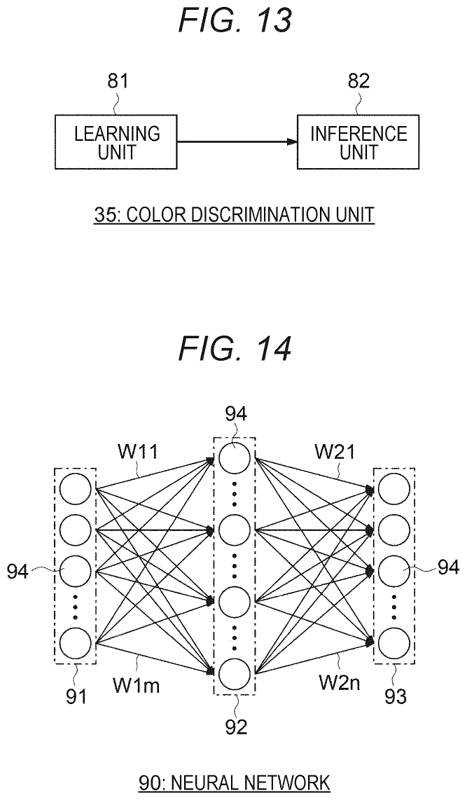

FIG. 13 is a functional block diagram illustrating an internal configuration of the color discrimination unit 35. As illustrated in FIG. 13, the color discrimination unit 35 includes a learning unit 81 and an inference unit 82.

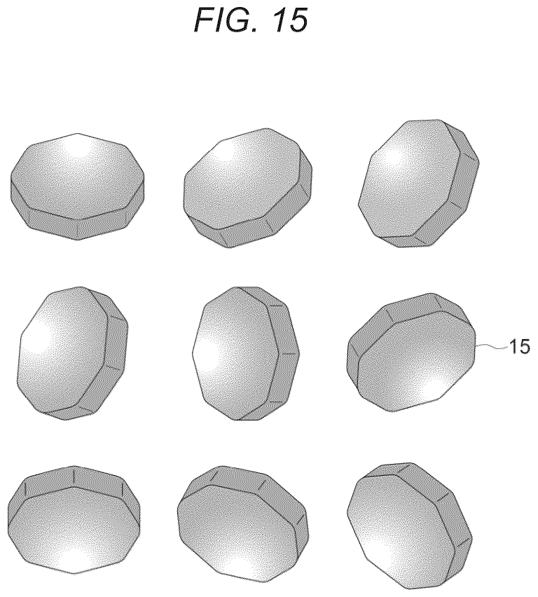

The learning unit 81 performs processing of updating the weighting factor of each node of a neural network 90, for example. FIG. 14 is a diagram illustrating an example of the neural network 90. The neural network 90 includes an input layer 91, an intermediate layer 92, and an output layer 93, and each layer includes a plurality of nodes 94. The plurality of nodes 94 of the input layer 91 is provided as many as the number of pieces of input data. In the present embodiment, the input data of the neural network 90 is two or more types of images acquired by the image acquisition unit 34. Each image includes 8-bit pixel data for each RGB color, and each pixel data of each image is input to the input layer 91 of the neural network 90. For example, the input data input to the input layer 91 of the neural network 90 may include data other than the visible image, the reflection suppressing image, or the reflection component image. In addition, sensing data of a depth sensor that detects depth information and sensing data of an infrared ray (IR) optical sensor, a short wave infrared (SWIR: Short Wave Infrared Radiometer) sensor, a multispectral sensor, or the like that images light in a wavelength band other than visible light (for example, infrared light) may be input to the neural network 90.

A plurality of signal paths is provided between each node 94 in the input layer 91 and each node 94 in the intermediate layer 92, and weighting factors W11 to W1m that can be updated are set for each signal path. A value obtained by multiplying the value of each node 94 of the input layer 91 by the weighting factor of the signal path connected to the node 94 is transmitted to the node 94 of the intermediate layer 92 that is the connection destination of the signal path. Each node 94 of the intermediate layer 92 is connected to a plurality of nodes 94 in the input layer 91. Each node 94 of the intermediate layer 92 is a value obtained by adding a value obtained by multiplying a weighting factor of a corresponding signal path to a value of each node 94 in the input layer 91 connected to the node 94. That is, in each node 94 of the intermediate layer 92, a product-sum operation process of adding a value obtained by multiplying a value of each node 94 of the input layer 91 by a weighting factor of a signal path connected to the node 94 for each signal path is performed.

In the neural network 90 of FIG. 14, the intermediate layer 92 includes only one layer, but the intermediate layer 92 may include a plurality of layers. As the number of intermediate layers 92 is increased, the learning effect can be enhanced although it takes time to learn.

A plurality of signal paths is connected between each node 94 of the intermediate layer 92 and each node 94 of the output layer 93, and weighting factors W21 to W2n that can be updated are set for these signal paths. From each node 94 of the output layer 93, information indicating the color of the target member 5, information indicating whether or not the color of the target member 5 matches a specific color, and the like are output.

The learning unit 81 sequentially inputs a plurality of reference images having known colors to the neural network 90 of FIG. 14, and repeats learning processing of updating the weighting factor so that a known color is output. The learning unit 81 performs learning processing using a plurality of reference images having not only known colors but also different surface treatment specifications and a plurality of reference images having approximate colors that are likely to cause color discrimination errors.

The reference image is obtained by imaging the target member 5 whose color and surface treatment specification are known by the camera system 71 in FIG. 12, and includes three types of images of a visible image, a reflection suppressing image, and a reflection component image for each reference image. For each of the plurality of reference images, the learning unit 81 sequentially inputs three types of images to the neural network 90 of FIG. 14, and updates the weighting factor so that a known color and a surface treatment specification are output.

As a specific example, the target member 5 whose color and surface treatment specification are known is captured by the camera system 71 of FIG. 12 to generate three types of images of a visible image, a reflection suppressing image, and a reflection component image, and a reference image (hereinafter, the first reference image) including these three types of images as a set is generated. In addition, another reference image (hereinafter, the second reference image) in which three types of images captured under different imaging conditions of the camera system 71 using the same target member 5 constitute one set is generated. The change of the imaging condition is, for example, a change of the illumination luminance of the illumination light source 3, a change of the white balance, or the like. Further, another reference image (hereinafter, the third reference image) in which three types of images captured at different distances from the camera system 71 using the same target member 5 constitute one set is generated. In addition, another reference image (hereinafter, the fourth reference image) including three types of images captured while changing the posture of the same target member 5 as one set is generated. Further, another reference image (hereinafter, the fifth reference image) including three types of images captured while changing the focus adjustment amount of the same target member 5 is generated.

As described above, for example, the first to fifth reference images may be generated for one target member 5 whose color and surface treatment specification are known, and the weighting factor of the neural network 90 may be updated using these first to fifth reference images.

In a case where the target member 5 has a complicated shape, the hue may change due to a change in brightness at the time of imaging or the like depending on the posture of the target member 5. FIG. 15 is a diagram illustrating an example in which the posture of the same target member 5 is variously changed. As illustrated in the drawing, even if the color of the target member 5 is the same, the brightness of the polarized image captured by the camera system 71 is partially changed depending on the posture of the target member 5, and there is a possibility that the target member 5 is recognized as a different color. In particular, in a case where the surface of the target member 5 includes a curved surface, the hue is likely to change depending on the posture. Therefore, the learning unit 81 may perform the learning processing of the neural network 90 using reference images of multiple postures in which the posture of the target member 5 whose color and surface treatment specification are known is variously changed.

Furthermore, the learning unit 81 may perform learning processing of the neural network 90 using a plurality of reference images captured under a plurality of environments having different exposure conditions and white balance.

Furthermore, the learning unit 81 may perform learning processing of the neural network 90 using the reference image captured under a situation with glare.

In addition, the learning unit 81 may perform the learning processing of the neural network 90 using a plurality of reference images obtained by imaging the target member 5 of an approximate color which is likely to be erroneously determined.

Due to a plurality of factors such as a difference in posture of the target member 5, a variation in disturbance such as an environmental condition at the time of imaging, and a variation in imaging distance and imaging timing, the captured images may not be recognized as the same color even if they originally have the same color. Therefore, it is desirable that the learning unit 81 perform learning processing of the neural network 90 in advance using various reference images in consideration of a difference in posture of the target member 5, variations in disturbance such as environmental conditions, variations in imaging distance and imaging timing, and the like.

In addition, as a new color is added to the target member 5, the learning unit 81 may acquire an image of the target member 5 in the new color again and perform the learning processing. It is desirable that the inference unit 82 perform inference processing on the basis of a result of relearning by the learning unit 81.

Furthermore, when the learning unit 81 performs the learning processing of the neural network 90, it is desirable to manually set the exposure condition and the white balance of the camera system 71. This is because when the exposure condition and the white balance are automatically controlled at the time of imaging, the brightness changes for each reference image, and there is a possibility that appropriate learning processing cannot be performed. However, in preparation for a case where the color discrimination of the target member 5 is performed under different imaging conditions, the learning processing may be performed using a plurality of reference images in a state where the exposure condition and the white balance of the camera system 71 are automatically set.

In a case where colors of a plurality of target members 5 flowing in the manufacturing line are discriminated or the like, distances between the target members 5 and the camera system 71 may vary. As a countermeasure against this, the learning processing of the neural network 90 may be performed using a plurality of reference images having different distances to the camera system 71.

The product-sum operation and the update of the weighting factor in each layer of the neural network 90 may be performed by the learning unit 81 in the color discrimination unit 35 provided in the camera system 71, or may be performed by the learning unit 81 in the color discrimination unit 35 provided on the cloud server 72. In a case where the product-sum operation and the weighting factor update are performed on the cloud server 72, the learning unit 81 transmits the pixel data and the color discrimination information of the three types of images constituting the reference image used for learning to the cloud server 72 via the application processor 75. The cloud server 72 repeats the product-sum operation and updates the weighting factor using the pixel data and the color discrimination information from the learning unit 81. The updated weighting factor is stored on the cloud server 72. Note that the cloud server 72 in FIG. 12 may be an on-premises server or a server provided by a cloud service provider.

By performing the product-sum operation of the neural network 90 and the update of the weighting factor on the cloud server 72, the processing load of the learning unit 81 can be reduced, and the price of the camera system 71 can be suppressed.

The inference unit 82 inputs two or more types of images acquired from the visible image, the reflection suppressing image, and the reflection component image obtained by imaging the target member 5 to the learned neural network 90, and discriminates the color of the target member 5. As described above, in a case where the neural network 90 is on the cloud server 72, the inference unit 82 transmits pixel data constituting two or more types of images to the cloud server 72 via the application processor 75. The cloud server 72 inputs the received pixel data to the neural network 90, performs product-sum operation, and transmits the color discrimination result output from the output layer 93 to the inference unit 82 via the application processor 75.

For example, the inference unit 82 can continuously discriminates the colors of the plurality of target members 5 flowing through the manufacturing line, and the application processor 75 can send an instruction to the arm control unit 79 to remove the target member 5 having an abnormality in color from the manufacturing line.

In order to continuously discriminate the colors of the plurality of target members 5 flowing through the manufacturing line, rapidity is required. Therefore, only the learning processing may be performed by the cloud server 72, the weighting factor or the like of the learned neural network 90 may be transmitted from the cloud server 72 to the inference unit 82, the product-sum operation of the neural network 90 may be performed inside the inference unit 82, and the color discrimination result may be acquired. This makes it possible to quickly acquire a color discrimination result.

As described above, in the color discrimination device 30 according to the second embodiment, the learning processing of the neural network 90 is performed using various reference images whose colors and surface treatment specifications are known, two or more types of images among the visible image, the reflection suppressing image, and the reflection component image of the target member 5 are input to the learned neural network 90, and the color discrimination is performed by the neural network 90. As a result, an accurate color can be discriminated in consideration of the surface treatment specification of the target member 5. Furthermore, for the target member 5 having a complicated shape, the learning processing of the neural network 90 is performed in advance using reference images of multiple postures, so that the color can be accurately discriminated even for the target member 5 whose posture has changed. Furthermore, in a case where there is a possibility that the distance from the target member 5 to the camera system 71 varies, it is possible to accurately discriminates the colors of the target members 5 having different distances by performing learning processing of the neural network 90 using various reference images located at different distances in advance.

According to the second embodiment, the learning processing of the neural network 90 is performed on the basis of the plurality of reference images in consideration of the change in the environmental condition and the imaging condition, the presence or absence of reflection on the target member 5, the posture change of the target member 5, the target member 5 of the approximate color, and the like, so that the color discrimination processing excellent in robustness and expandability can be performed.

### Third Embodiment

The color discrimination device 30 according to the third embodiment discriminates the color of the target member 5 without using machine learning.

The color discrimination device 30 according to the third embodiment has a block configuration similar to that in FIG. 12, but the processing operation of the color discrimination unit 35 is different from that of the second embodiment. The signal processing unit 74 according to the third embodiment performs processing of the RAW image processing unit 31, the image extraction unit 32, the color conversion unit 33, and the image acquisition unit 34 illustrated in FIG. 6. Unlike the second embodiment, in the third embodiment, the color conversion unit 33 is essential.

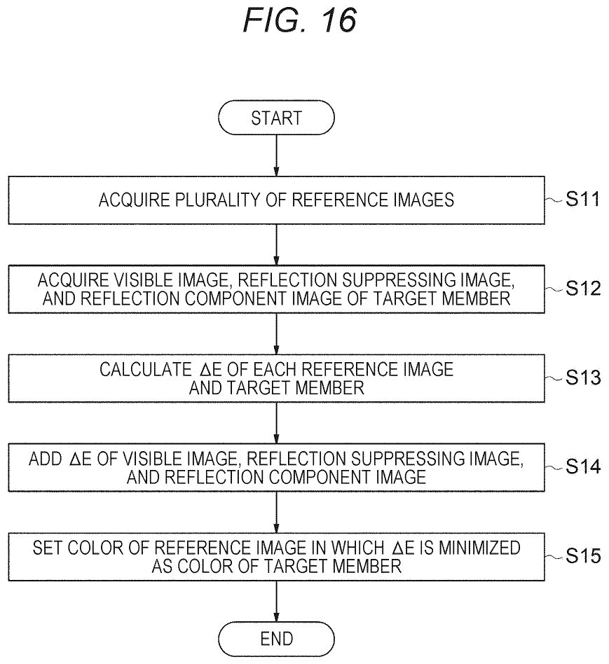

FIG. 16 is a flowchart illustrating a processing operation of the color discrimination unit 35 according to the third embodiment. First, in order to generate a plurality of reference images, a plurality of target members 5 whose colors and surface treatment specifications are known are prepared. Then, the plurality of target members 5 is captured by the camera system 71 to generate a plurality of reference images (step S11). Each reference image includes a visible image, a reflection suppressing image, and a reflection component image, and a value digitized by the color conversion unit 33 is acquired in advance.

In step S11, a plurality of reference images obtained by imaging the target member 5 whose color and surface treatment specification are known under different environmental conditions or different reflection conditions may be acquired. Further, in step S11, a plurality of reference images obtained by imaging a plurality of target members 5 having an approximate color may be acquired. Furthermore, in step S11, a plurality of reference images obtained by imaging the target member 5 under a plurality of imaging conditions having different exposure conditions and white balance may be acquired.

Next, the target member 5 whose color is desired to be discriminated is captured by the camera system 71, and a visible image, a reflection suppressing image, and a reflection component image are acquired (step S12). Each acquired image is converted into digitized data by the color conversion unit 33.

Next, a difference ΔE between the digitized data of each image acquired in step S12 and the digitized data of the reference image is calculated (step S13). The color conversion unit 33 generates digitized data obtained by digitizing RGB pixel data for each pixel. In step S13, a difference ΔE between values obtained by averaging digitized data of a plurality of pixels in the partial image extracted by the image extraction unit 32 is calculated. That is, the difference ΔE between the average value of the digitized data of each pixel in each partial image of the visible image, the reflection suppressing image, and the reflection component image of the target member 5 whose color is desired to be discriminated and the average value of the digitized data of each pixel in each partial image of the visible image, the reflection suppressing image, and the reflection component image constituting the reference image is calculated.

Here, the difference ΔE is calculated between the visible images, between the reflection suppressing images, or between the reflection component images. That is, the difference ΔE between the digitized data of the visible image of the target member 5 and the digitized data of the visible image of the reference image is calculated. In addition, the difference ΔE between the digitized data of the reflection suppressing image of the target member 5 and the digitized data of the reflection suppressing image of the reference image is calculated. Furthermore, the difference ΔE between the digitized data of the reflection component image of the target member 5 and the digitized data of the reflection component image of the reference image is calculated.

The processing in step S13 is performed for each reference image. That is, the difference ΔE between the digitized data of the target member 5 and the digitized data of the reference image is calculated for each of the plurality of reference images. Therefore, three types of differences ΔE are calculated for each reference image.

Next, a value obtained by adding the three types of ΔΕ calculated in step S13 is calculated for each reference image (step S14). The reference image having a smaller sum indicates that the color is closer to the color of the target member 5.

Next, a reference image having the minimum sum of the differences ΔE calculated in step S14 is specified, and the color of the specified reference image is determined as the color of the target image (step S15).

In the flowchart of FIG. 16, the sum of the difference ΔE between the visible images, the difference ΔE between the reflection suppressing images, and the difference ΔE between the reflection component images is calculated for the target member 5 of which the color is desired to be discriminated and the target member 5 of which the color and the surface treatment specification are known. However, the color of the target member 5 may be discriminated on the basis of the color of the reference image in which the sum of the two types of differences ΔE among the three types of differences ΔE is minimized.

As described above, in the third embodiment, a plurality of reference images of which colors and surface treatment specifications are known are acquired in advance, a sum of differences ΔE between two or more types of images among the visible image, the reflection suppressing image, and the reflection component image of these reference images and two or more types of images among the visible image, the reflection suppressing image, and the reflection component image of the target member 5 of which colors are desired to be discriminated is calculated for each reference image, and a color of the reference image having the minimum sum is set as a color of the target image. This facilitates color discrimination processing.

### <Application to Other Use Cases>

The color discrimination device 30 according to the first to third embodiments can be applied to various use cases. For example, in a manufacturing factory that manufactures some part, the material (for example, a glass material, a metal material, a resin material, or the like) of the part can be identified by discriminating the color of the surface of the part.

In addition, by discriminating the color of the road surface, it is possible to analyze the road surface such as a puddle, ice and snow, and oil on the road surface and use it for automated driving.

Furthermore, by discriminating the color of the surface of the member, it is possible to determine coating unevenness and color loss of a member constituted by various materials such as plastic, metal, and resin.

In addition, the food and drink can be sorted according to the grade, the degree of ripeness, freshness, and the like by discriminating the color of the food and drink such as meat and fruits.

Further, by discriminating the color of the printed matter, it is possible to determine the variation in the color specification (hue, saturation, brightness, and the like) of the printed matter and to inspect the presence or absence of a defect.

In addition, it is possible to inspect quality defects of pharmaceuticals, cosmetics, and the like by discriminating colors of pharmaceuticals, cosmetics, and the like.

### <Application Example to Moving Body>

The technology according to the present disclosure (present technology) can be applied to various products. For example, the technology according to the present disclosure may be implemented in a form of a device to be mounted to a moving body of any type such as an automobile, an electric vehicle, a hybrid electric vehicle, a motorcycle, a bicycle, a personal mobility, an airplane, a drone, a ship, and a robot.

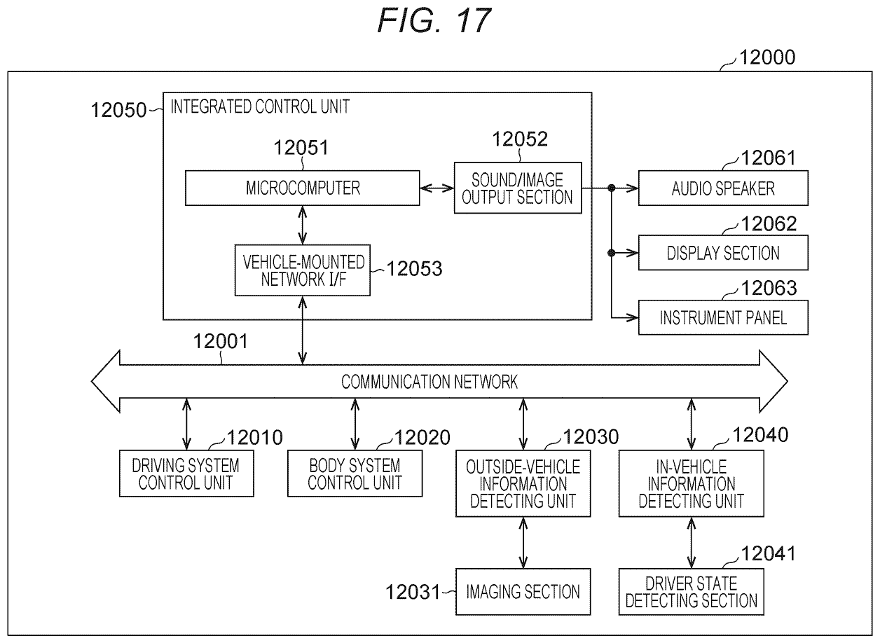

FIG. 17 is a block diagram illustrating a schematic configuration example of a vehicle control system as an example of a moving body control system to which the technology according to the present disclosure can be applied.

The vehicle control system 12000 includes a plurality of electronic control units connected to each other via a communication network 12001. In the example illustrated in FIG. 17, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle acquired by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example in FIG. 17, as the output device, an audio speaker 12061, a display section 12062, and an instrument panel 12063 are illustrated. The display section 12062 may, for example, include at least one of an on-board display and a head-up display.

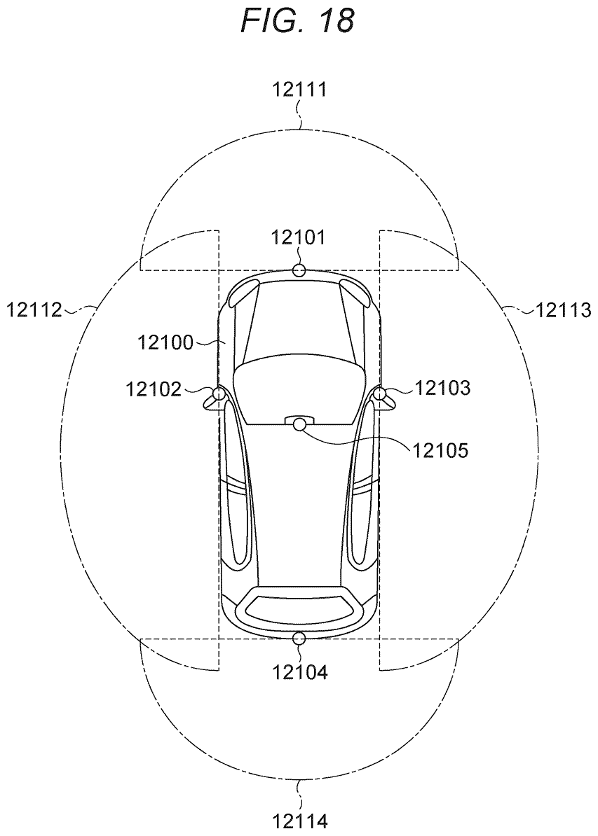

FIG. 18 is a diagram illustrating an example of the installation position of the imaging section 12031.

In FIG. 18, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

It is to be noted that, FIG. 18 illustrates examples of imaging ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure can be applied to the imaging section 12031 and the like in the configuration described above. Specifically, the color discrimination device 30 of the present disclosure can be applied to the imaging section 12031. By applying the technology according to the present disclosure to the imaging section 12031, a clearer captured image can be obtained, so that driver's fatigue can be reduced.

Note that the present technology can have the following configurations.
(1) A color discrimination device including:
an image acquisition unit that acquires two or more types of images among a visible image including a visible light component obtained by imaging a subject, a reflection suppressing image in which a reflected light component is suppressed, and a reflection component image from which the reflected light component is extracted; and a color discrimination unit that discriminates a color of the subject on the basis of the two or more types of images acquired by the image acquisition unit.
(2) The color discrimination device according to (1), in which the color discrimination unit discriminates the color of the subject on the basis of a result of comparing each of the two or more types of images acquired by the image acquisition unit with a plurality of reference images each having a known color and a surface treatment specification.
(3) The color discrimination device according to (1), in which the color discrimination unit discriminates the color of the subject on the basis of a result of comparing each of the two or more types of images acquired by the image acquisition unit with a plurality of reference images each having a known color and a surface treatment specification captured under at least one of different environmental conditions or imaging conditions.
(4) The color discrimination device according to (2) or (3), further including an image extraction unit that extracts a partial image of a specific part of the subject from each of the two or more types of images and extracts a partial reference image of the specific part from each of the plurality of reference images, in which the color discrimination unit discriminates the color of the subject on the basis of a result of comparing each of two or more types of the partial image with each of a plurality of the partial reference image.
(5) The color discrimination device according to any one of (2) to (4), further including:
a model construction unit that constructs a machine learning model that discriminates a color of the subject on the basis of the two or more types of images input; and
a learning unit that performs learning of the machine learning model on the basis of the plurality of reference images,
in which the color discrimination unit discriminates the color of the subject on the basis of a color output from the machine learning model when the two or more types of images are input to the machine learning model.
(6) The color discrimination device according to (5), in which the learning unit learns the machine learning model on the basis of the plurality of reference images each having a known color and a surface treatment specification.
(7) The color discrimination device according to (5), in which the learning unit learns the machine learning model on the basis of the plurality of reference images captured under at least one of a plurality of different environmental conditions or imaging conditions.
(8) The color discrimination device according to (5), in which the learning unit learns the machine learning model on the basis of the plurality of reference images each having a different posture of the subject.
(9) The color discrimination device according to any one of (5) to (8), in which
the machine learning model includes a neural network having an updatable weighting factor, and the learning unit updates the weighting factor on the basis of the plurality of reference images.
(10) The color discrimination device according to any one of (5) to (9), in which
each of the plurality of reference images includes a reference visible image including a visible light component, a reference reflection suppressing image in which a reflected light component is suppressed, and a reference reflection component image from which the reflected light component is extracted, and
the learning unit learns the machine learning model on the basis of a plurality of the reference visible image, a plurality of the reference reflection suppressing image, and a plurality of the reference reflection component image corresponding to the plurality of reference images.
(11) The color discrimination device according to any one of (5) to (10), in which the model construction unit is provided in a server connected to a network.
(12) The color discrimination device according to any one of (2) to (4), further including:
a digitizing unit that digitizes each of the two or more types of images acquired by the image acquisition unit and the plurality of reference images; and
a difference calculation unit that calculates a difference between a value obtained by digitizing each of the two or more types of images by the digitizing unit and a value obtained by digitizing the plurality of reference images by the digitizing unit,
in which the color discrimination unit discriminates the color of the subject on the basis of the difference calculated by the difference calculation unit.
(13) The color discrimination device according to (12), in which
each of the plurality of reference images includes a reference visible image including a visible light component, a reference reflection suppressing image in which a reflected light component is suppressed, and a reference reflection component image from which the reflected light component is extracted, and
the difference calculation unit calculates the difference on the basis of a value obtained by digitizing each of the visible image, the reflection suppressing image, and the reflection component image corresponding to the two or more types of images by the digitizing unit and a value obtained by digitizing each of the reference visible image, the reference reflection suppressing image, and the reference reflection component image corresponding to each of the plurality of reference images by the digitizing unit.
(14) The color discrimination device according to (13), in which
the difference calculation unit calculates a sum of a first difference between a value obtained by digitizing the visible image by the digitizing unit and a value obtained by digitizing the reference visible image by the digitizing unit, a second difference between a value obtained by digitizing the reflection suppressing image by the digitizing unit and a value obtained by digitizing the reference reflection suppressing image by the digitizing unit, and a third difference between a value obtained by digitizing the reflection component image by the digitizing unit and a value obtained by digitizing the reference reflection component image by the digitizing unit, and
the color discrimination unit determines, as the color of the subject, a color of the reference image having a minimum sum calculated by the difference calculation unit.
(15) The color discrimination device according to any one of (1) to (14), further including:
an imaging section that outputs a polarized image obtained by imaging the subject; and
a polarization signal processing unit that generates the visible image, the reflection suppressing image, and the reflection component image on the basis of the polarized image,
in which the image acquisition unit generates two or more types of images among the visible image, the reflection suppressing image, and the reflection component image on the basis of the polarized image.
(16) The color discrimination device according to (15), further including an illumination light source that illuminates the subject with light polarized at a predetermined polarization angle when the imaging section images the subject.
(17) The color discrimination device according to (2), (3), or (6), in which the surface treatment specification includes at least one of metallic coating or solid coating of the subject.
(18) A color discrimination method including:
acquiring two or more types of images among a visible image including a visible light component obtained by imaging a subject, a reflection suppressing image in which a reflected light component is suppressed, and a reflection component image from which the reflected light component is extracted; and
discriminating a color of the subject on the basis of the two or more types of images previously acquired.

Aspects of the present disclosure are not limited to the above-described individual embodiments, but include various modifications that can be conceived by those skilled in the art, and the effects of the present disclosure are not limited to the above-described contents. That is, various additions, modifications, and partial deletions can be made without departing from the conceptual idea and spirit of the present disclosure derived from the contents defined in the claims and equivalents thereof.

### REFERENCE SIGNS LIST

1 Color discrimination system
2 Camera
3 Illumination light source
5 Target member
5a Rectangular region
6 Imaging section
7 Warning lamp
10 Pixel unit
10a Photoelectric conversion unit
10b Light shielding member
11 Planarization layer
12 Light shielding layer
13 Underlying insulating layer
14 Insulating layer
15 Polarizing element
15d Line portion
15e Space portion
15f Light reflection layer
15g Insulating layer
15h Light absorbing layer
16 Protective layer
17 Planarization layer
18 Color filter layer
19 On-chip lens
20 Substrate
21 Wiring layer
22 Polarizing filter
30 Color discrimination device
31 RAW image processing unit
32 Image extraction unit
33 Color conversion unit
34 Image acquisition unit
35 Color discrimination unit
41 Clamp gain control unit
42 White balance adjustment unit
43 Demosaic processing unit
44 Polarization signal processing unit
45 Linear matrix unit
46 Gamma correction unit
47 Sharpness adjustment unit
48 Gain adjustment unit
51 Non-polarization intensity calculation unit
52 Polarization intensity calculation unit
53 Subtractor
61 In-frame average value calculation unit
62 Gamma inverse conversion processing unit
63 XYZ color space conversion unit
64 CIELAB color space conversion unit
71 Camera system
72 Cloud server
73 Polarization sensor
74 Signal processing unit
75 Application processor
76 Analog-digital converter
77 Network
78 Display unit
79 Arm control unit
81 Learning unit
82 Inference unit
90 Neural network
91 Input layer
92 Intermediate layer
93 Output layer
94 Node

1. A color discrimination device comprising:
an image acquisition unit that acquires two or more types of images among a visible image including a visible light component obtained by imaging a subject, a reflection suppressing image in which a reflected light component is suppressed, and a reflection component image from which the reflected light component is extracted; and
a color discrimination unit that discriminates a color of the subject on a basis of the two or more types of images acquired by the image acquisition unit.

2. The color discrimination device according to claim 1, wherein the color discrimination unit discriminates the color of the subject on a basis of a result of comparing each of the two or more types of images acquired by the image acquisition unit with a plurality of reference images each having a known color and a surface treatment specification.

3. The color discrimination device according to claim 1, wherein the color discrimination unit discriminates the color of the subject on a basis of a result of comparing each of the two or more types of images acquired by the image acquisition unit with a plurality of reference images each having a known color and a surface treatment specification captured under at least one of different environmental conditions or imaging conditions.

4. The color discrimination device according to claim 2, further comprising an image extraction unit that extracts a partial image of a specific part of the subject from each of the two or more types of images and extracts a partial reference image of the specific part from each of the plurality of reference images,
wherein the color discrimination unit discriminates the color of the subject on a basis of a result of comparing each of two or more types of the partial image with each of a plurality of the partial reference image.

5. The color discrimination device according to claim 2, further comprising:
a model construction unit that constructs a machine learning model that discriminates a color of the subject on a basis of the two or more types of images input; and
a learning unit that performs learning of the machine learning model on a basis of the plurality of reference images,
wherein the color discrimination unit discriminates the color of the subject on a basis of a color output from the machine learning model when the two or more types of images are input to the machine learning model.

6. The color discrimination device according to claim 5, wherein the learning unit performs learning of the machine learning model on a basis of the plurality of reference images each having a known color and a surface treatment specification.

7. The color discrimination device according to claim 5, wherein the learning unit performs learning of the machine learning model on a basis of the plurality of reference images captured under at least one of a plurality of different environmental conditions or imaging conditions.

8. The color discrimination device according to claim 5, wherein the learning unit performs learning of the machine learning model on a basis of the plurality of reference images each having a different posture of the subject.

9. The color discrimination device according to claim 5, wherein
the machine learning model includes a neural network having an updatable weighting factor, and
the learning unit updates the weighting factor on a basis of the plurality of reference images.

10. The color discrimination device according to claim 5, wherein
each of the plurality of reference images includes a reference visible image including a visible light component, a reference reflection suppressing image in which a reflected light component is suppressed, and a reference reflection component image from which the reflected light component is extracted, and
the learning unit performs learning of the machine learning model on a basis of a plurality of the reference visible image, a plurality of the reference reflection suppressing image, and a plurality of the reference reflection component image corresponding to the plurality of reference images.

11. The color discrimination device according to claim 5, wherein the model construction unit is provided in a server connected to a network.

12. The color discrimination device according to claim 2, further comprising:
a digitizing unit that digitizes each of the two or more types of images acquired by the image acquisition unit and the plurality of reference images; and
a difference calculation unit that calculates a difference between a value obtained by digitizing each of the two or more types of images by the digitizing unit and a value obtained by digitizing the plurality of reference images by the digitizing unit,
wherein the color discrimination unit discriminates the color of the subject on a basis of the difference calculated by the difference calculation unit.

13. The color discrimination device according to claim 12, wherein
each of the plurality of reference images includes a reference visible image including a visible light component, a reference reflection suppressing image in which a reflected light component is suppressed, and a reference reflection component image from which the reflected light component is extracted, and
the difference calculation unit calculates the difference on a basis of a value obtained by digitizing each of the visible image, the reflection suppressing image, and the reflection component image corresponding to the two or more types of images by the digitizing unit and a value obtained by digitizing each of the reference visible image, the reference reflection suppressing image, and the reference reflection component image corresponding to each of the plurality of reference images by the digitizing unit.

14. The color discrimination device according to claim 13, wherein
the difference calculation unit calculates a sum of a first difference between a value obtained by digitizing the visible image by the digitizing unit and a value obtained by digitizing the reference visible image by the digitizing unit, a second difference between a value obtained by digitizing the reflection suppressing image by the digitizing unit and a value obtained by digitizing the reference reflection suppressing image by the digitizing unit, and a third difference between a value obtained by digitizing the reflection component image by the digitizing unit and a value obtained by digitizing the reference reflection component image by the digitizing unit, and
the color discrimination unit determines, as the color of the subject, a color of the reference image having a minimum sum calculated by the difference calculation unit.

15. The color discrimination device according to claim 1, further comprising:
an imaging section that outputs a polarized image obtained by imaging the subject; and
a polarization signal processing unit that generates the visible image, the reflection suppressing image, and the reflection component image on a basis of the polarized image,
wherein the image acquisition unit generates two or more types of images among the visible image, the reflection suppressing image, and the reflection component image on a basis of the polarized image.

16. The color discrimination device according to claim 15, further comprising an illumination light source that illuminates the subject with light polarized at a predetermined polarization angle when the imaging section images the subject.

17. The color discrimination device according to claim 2, wherein the surface treatment specification includes at least one of metallic coating or solid coating of the subject.

18. A color discrimination method comprising:
acquiring two or more types of images among a visible image including a visible light component obtained by imaging a subject, a reflection suppressing image in which a reflected light component is suppressed, and a reflection component image from which the reflected light component is extracted; and
discriminating a color of the subject on a basis of the two or more types of images previously acquired.
